(19) United States
(12) Patent Application Publication
(10) Pub. No.: US 2020/0120112 A1
(43) Pub. Date: Apr. 16, 2020

(54) TECHNIQUES FOR DETECTING KNOWN VULNERABILITIES IN SERVERLESS FUNCTIONS AS A SERVICE (FAAS) PLATFORM

(71) Applicant: Nuweba Labs Ltd., Tel Aviv-Jaffa (IL)

(72) Inventor: Yan CYBULSKI, Tel-Aviv (IL)

(73) Assignee: Nuweba Labs Ltd., Tel Aviv-Jaffa (IL)

(21) Appl. No.: 16/598,220

(22) Filed: Oct. 10, 2019

Related U.S. Application Data
(60) Provisional application No. 62/744,099, filed on Oct. 10, 2018.

(51) Int. Cl. H04L 29/06

(52) U.S. Cl. CPC H04L 63/1416; H04L 63/20; H04L 63/0281; H04L 63/101; H04L 63/0245

(57) ABSTRACT

A system and method for protecting a serverless Function as a Service (FaaS) platform from vulnerabilities are provided. The method includes receiving input and output (I/O) communication directed to a serverless function executed over the FaaS platform; analyzing the received I/O communication by applying a predefined set of filtration rules, wherein the predefined set of filtration rules input filtration rules and output filtration rules being independently applied on the received I/O communication; detecting based on the predefined set of filtration rules analysis, at least one malicious I/O pattern; and alerting on a detection of vulnerability when deterring the at least one malicious I/O pattern.

### CROSS-REFERENCE TO RELATED APPLICATIONS

This application claims the benefit of U.S. Provisional Application No. 62/744,099 filed on Oct. 10, 2018, the contents of which are hereby incorporated by reference.

### TECHNICAL FIELD

The present disclosure relates generally to cloud computing services, and more specifically to securing function as a service (FaaS) platforms.

### BACKGROUND

Organizations have increasingly adapted their applications to be run from multiple cloud computing platforms. Some leading public cloud service providers include Amazon®, Microsoft®, Google®, and the like. Serverless computing platforms provide a cloud computing execution model in which the cloud provider dynamically manages the allocation of machine resources. Such platforms, also referred to as function as a service (FaaS) platforms, allow execution of application logic without requiring storing data on the client's servers. Commercially available platforms include AWS Lambda by Amazon®, Azure® Functions by Microsoft®, Google Cloud Functions Cloud Platform by Google®, OpenWhisk by IBM®, and the like.

“Serverless computing” is a misnomer, as servers are still employed. The name “serverless computing” is used to indicate that the server management and capacity planning decisions of serverless computing functions are not managed by the developer or operator. Serverless code can be used in conjunction with code deployed in traditional styles, such as microservices. Alternatively, applications can be written to be purely serverless and to use no provisioned services at all.

Further, FaaS platforms do not require coding to a specific framework or library. FaaS functions are regular functions with respect to programming language and environment. Typically, functions in FaaS platforms are triggered by event types defined by the cloud provider. Functions can also be trigged by manually configured events or when a function calls another function. For example, in Amazon® AWS®, such triggers include file (e.g., S3) updates, passage of time (e.g., scheduled tasks), and messages added to a message bus. A programmer of the function would typically have to provide parameters specific to the event source it is tied to.

A serverless function is typically programmed and deployed using command line interface (CLI) tools, an example of which is a serverless framework. In most cases, the deployment is automatic and the function's code is uploaded to the FaaS platform. A serverless function can be written in different programming languages, such as JavaScript®, Python®, Java®, and the like. A function typically includes a handler (e.g., handler.js) and third-party libraries accessed by the code of the function. A serverless function also requires a framework file as part of its configuration. Such a file (e.g., serverless.yml) defines at least one event that triggers the function and resources to be utilized, deployed or accessed by the function (e.g., database).

Some serverless platform developers have sought to take advantage of the benefits of software containers. For example, one of the main advantages of using software containers is the relatively fast load times as compared to virtual machines. However, while load times such as 100 ms may be fast as compared to VMs, such load times are still extremely slow for the demands of FaaS infrastructures.

FIG. 1 shows an example diagram 100 illustrating a FaaS platform 110 providing functions for various services 120-1 through 120-6 (hereinafter referred to as services 120 for simplicity). Each of the services 120 may utilize one or more of the functions provided by respective software containers 115-1 through 115-4 (hereinafter referred to as a software container 115 or software containers 115 for simplicity). Each software container 115 receives requests from the services 120 and provides functions in response. To this end, each software container 115 includes code of the respective function. When multiple requests for the same software container 115 are received around the same time, a performance bottleneck occurs.

FaaS platforms, like as other computing platforms, face some security vulnerabilities. One vulnerability in ephemeral execution environments is caused by the invocation of functions. The ephemeral execution provides, on each execution, a clean environment without any changes that can occur after code starts its execution without any unexpected bugs or problems. However, this requires running servers for a prolonged time. Further, some FaaS providers offer environment reuse (container reuse) to compensate for high cold start time (or warm start). The ephemerality execution demonstrates a risk as the software container maintains persistency when an attacker successfully gains access to a function environment.

Another vulnerability can be the result of manipulation of a serverless function's flow. Manipulating the flow can lead to malicious activity, such as remote code execution (RCE), data leak, malware injection, and the like.

Another vulnerability in FaaS platforms results from an interface to a network (e.g., the Internet). Today, developers of serverless functions do not have fine-grained control over network traffic flowing in and out of a software container. For example, developers in an Amazon® cloud environment usually bind a Lambda serverless function to an Amazon® virtual private cloud (VPC) to control the function's network traffic. The network traffic is a suitable solution regarding price, performance (heavy performance degradation), and complexity of operation.

Another vulnerability in FaaS platforms results from utilization of environment variables in order to simplify and abstract function configuration and the use of credentials. Such variables are provided through an API or a user interface and utilized by invocation of a function. Sometimes the environment variables are stored in a secure way while at rest. Environment variables are also used to pass the function sensitive information such as third-party credentials to be used inside the function in order to access APIs of third-party providers, such as Slack®, GitHub, Twillo, and the like.

A provider of a FaaS platform can also inject into the environment function credentials that grant access to other services inside the provider cloud IAM credentials in AWS). The credentials are injected using environment variables.

While some providers secure the environment variables at rest or provide temporary credentials, utilization of environment variables still poses security risks for the sensitive credentials that are visible inside the function environment. That is, an attacker who gains access to the function environment can leak the credentials and cause real damage to a company even if the credentials are valid for a short period of time (usually 1 hour).

Other vulnerabilities include misconfiguration of security settings (e.g., web application firewall) and logical vulnerabilities (due to incorrect coding). Such vulnerabilities are difficult to detect because they can appear as regular traffic.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for protecting a serverless Function as a Service (FaaS) platform from vulnerabilities. The method comprises: receiving input and output (I/O) communication directed to a serverless function executed over the FaaS platform; analyzing the received I/O communication by applying a predefined set of filtration rules, wherein the predefined set of filtration rules input filtration rules and output filtration rules being independently applied on the received I/O communication; detecting based on the predefined set of filtration rules analysis, at least one malicious I/O pattern; and alerting on a detection of vulnerability when deterring the at least one malicious I/O pattern.

Certain other embodiments disclosed herein include a reverse proxy for protecting a serverless Function as a Service (FaaS) platform from vulnerabilities. The reverse proxy comprises: a processing circuitry; and a memory, the memory containing instructions that, when executed by the processing circuitry, configure the reverse proxy to: receiving input and output (I/O) communication directed to a serverless function executed over the FaaS platform; analyzing the received I/O communication by applying a predefined set of filtration rules, wherein the predefined set of filtration rules input filtration rules and output filtration rules being independently applied on the received I/O communication; detecting based on the predefined set of filtration rules analysis, at least one malicious I/O pattern; and alerting on a detection of vulnerability when deterring the at least one malicious I/O pattern.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a function as a service (FaaS) platform providing functions for various services.

FIGS. 2A and 2B are diagrams illustrating a scalable FaaS platform designed to reduce the cold start latency according to the disclosed embodiments.

FIG. 3 is an example diagram illustrating the stacking of policies according to an embodiment.

FIG. 4 is a flowchart illustrating a process performed by the filtration security layer according to an embodiment.

FIG. 5 is a flowchart illustrating a process performed by the anomaly detection security layer according to an embodiment.

FIG. 6 is a schematic diagram of a schematic diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

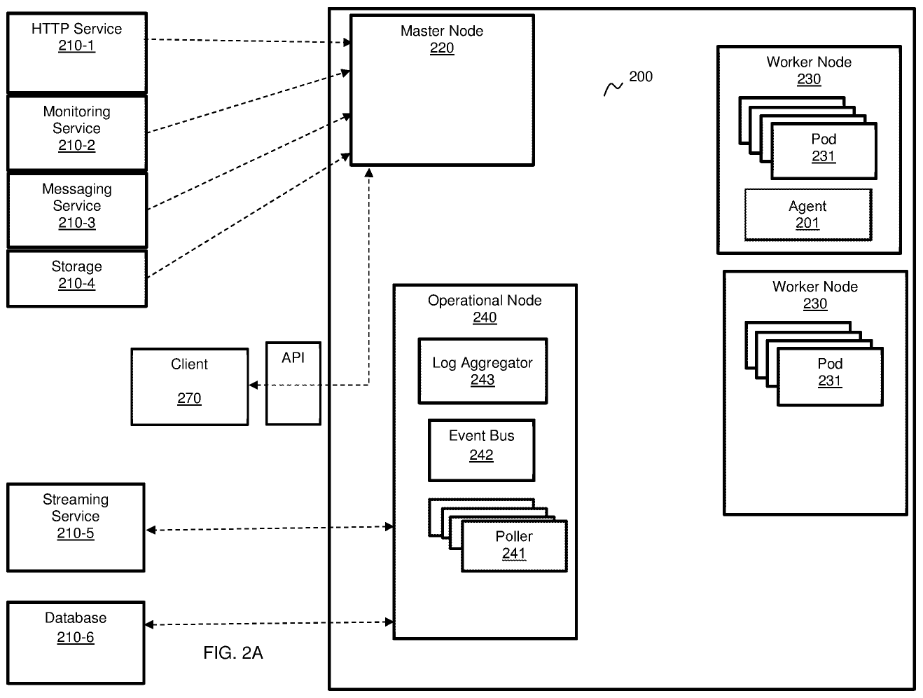

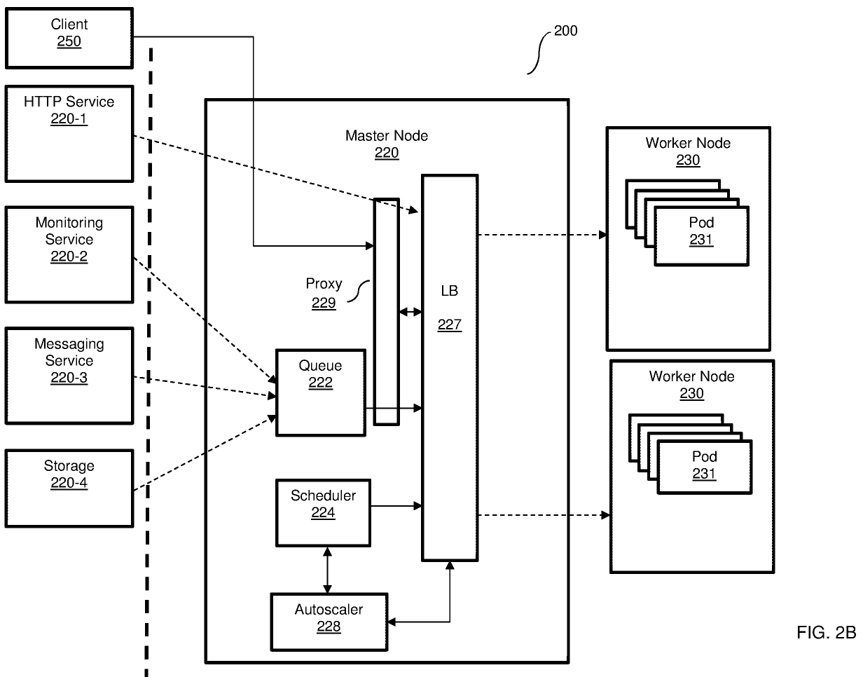

Some embodiments, disclosed herein, provide various security layers to detect and mitigate vulnerabilities in a FaaS platform and secure serverless functions (hereinafter “functions” or “function”). The disclosed security layers are operable in commercially available FaaS platforms supporting various types of functions, such as Amazon® Web Services (AWS) Lambda® functions, Azure® functions, and IBM® Cloud functions, and the like. In an embodiment, the security layers are operable in a secured scalable FaaS platform (hereinafter “the scalable FaaS platform”) designed according to some embodiments. An example scalable platform is provided below with reference to FIGS. 2A and 2B.

According to the disclosed embodiments, filtration and anomaly detection security layers are provided. The filtration layer is configured to filter inputs and outputs to the functions to and from a client. The anomaly detection security layer attempts to detect and track attackers executing malicious activity in the FaaS. In an embodiment, the anomaly detection security layer is further configured to generate an attack map demonstrating at least functions and/or resources in the FaaS platform exploited by the detected attackers.

FIG. 2A is an example diagram of a scalable FaaS platform 200 designed according to an embodiment. The scalable FaaS platform 200 is configured to secure execution of functions by providing the various security layers, and, in particular, the filtration and anomaly detection security layers.

In the scalable FaaS platform 200, software container pods are utilized according to the disclosed embodiments. Each pod is a software container including code for a respective function that acts as a template for each pod associated with that function. When a function is called, it is checked if a pod containing code for the function is available. If no appropriate pod is available, a new instance of the pod is added to allow the shortest possible response time for providing the function. In some configurations, when an active function is migrated to a new FaaS platform, a number of initial pods are re-instantiated on the new platform.

In an embodiment, each request for a function passes to a dedicated pod for the associated function. In some embodiments, each pod only handles one request at a time such that the number of concurrent requests for a function that are being served are equal to the number of running pods. Instances of the same pod may share a common physical memory or a portion of memory, thereby reducing total memory usage.

The pods may be executed in different environments, thereby allowing different types of functions in a FaaS platform to be provided. For example, Amazon® Web Services (AWS) Lambda functions, Azure® functions, and IBM® Cloud functions may be provided using the pods deployed in a FaaS platform as described herein. The functions are services for one or more containerized application platform (e.g., Kubernetes®). A function may trigger other functions.

The disclosed scalable FaaS platform 200 further provides an ephemeral execution environment for each invocation of a serverless function. This ensures that each function's invocation is executed to a clean environment, i.e., without any changes that can occur after beginning execution of the code that can cause unexpected bugs or problems. Further, an ephemeral execution environment is secured to prevent persistency in case an attacker successfully gains access to a function environment.

To provide an ephemeral execution environment, the scalable FaaS platform 200 is configured to prevent any reuse of a container. To this end, the execution environment of a software container (within a pod) is destroyed at the end of the invocation and each new request is served by a new execution environment. This is enabled by keeping pods warm for a predefined period through which new requests are expected to be received.

In an embodiment, the scalable FaaS platform 200 is configured to handle three different types of events that trigger execution of serverless functions. Such types of events include synchronized events, asynchronized events, and polled events. The synchronized events are passed directly to a cloud service to invoke the function in order to minimize latency. The asynchronized events are first queued before invoking a function. The polled events cause an operational node (discussed below) to perform a time loop that will check against a cloud provider service, and if there are any changes in the cloud service, a function is invoked.

In the example embodiment illustrated in FIG. 2A, the scalable FaaS platform 200 provides serverless functions to services 210-1 through 210-6 (hereinafter referred to individually as a service 210 or collectively as services 210 for simplicity) through the various nodes. A client 250 may also access serverless functions executed in the platform 200. In an embodiment, there are three different types of nodes: a master node 220, a worker node 230, and an operational node 240. In an embodiment, the scalable FaaS platform 200 includes a master node 220, one or more worker nodes 230, and one or more operational nodes 240.

The master node 220 is configured to orchestrate the operation of the worker nodes 230 and an operational node 240. A worker node 230 includes pods 231 configured to execute serverless functions. Each such pod 231 is a software container configured to perform a respective function such that, for example, any instance of the pod 231 contains code for the same function. The operational nodes 240 are utilized to run functions for the streaming and database services 210-5 and 210-6. The operational nodes 240 are further configured to collect logs and data from worker nodes 230.

In an embodiment, each operational node 240 includes one or more pollers 241, an event bus 242, and a log aggregator 243. A poller 241 is configured to delay provisioning of polled events indicating requests for functions. To this end, a poller 241 is configured to perform a time loop and to periodically check an external system (e.g., a system hosting one or more of the services 210) for changes in the state of a resource, e.g., a change in a database entry. When a change in state has occurred, the poller 241 is configured to invoke the function of the respective pod 231.

The event bus 242 is configured to allow communication between the other nodes and the other elements (e.g., the poller 241, log aggregator 243, or both) of the operational node 240. The log aggregator 243 is configured to collect logs and other reports from the worker nodes 230.

In an example implementation, the poller 241 may check the streaming service 210-5 and the database 210-6 for changes in state and, when a change in the state of one of the services 210-5 or 210-6 has occurred, invoke the function requested by the respective service 210-5 or 210-6.

In an embodiment, the master node 220 further includes a queue, a scheduler, a load balancer, and an auto-scaler (not shown in FIG. 2A), utilized during the scheduling of functions. The autoscaler is configured to receive events representing requests (e.g., from a kernel, for example a Linux kernel, of an operating system) and to scale the pod services according to demand. To this end, the autoscaler is configured to increase the number of pods as needed and that are available on-demand, while ensuring low latency. For example, when a request for a function that does not have an available pod is received, the autoscaler increases the number of pods. Thus, the autoscaler allows for scaling the platform per request.

The events may include, but are not limited to, synchronized events, asynchronized events, and polled events. The synchronized events may be passed directly to the pods to invoke their respective functions. The asynchronized events may be queued before invoking the respective functions.

It should be noted that, in a typical configuration, there is a small number of master nodes 220 (e.g., 1, 3, or 5 master nodes), and a larger number of worker nodes 230 and operational nodes 240 (e.g., millions). The worker nodes 230 and operational nodes 240 are scaled on demand.

In an embodiment, the nodes 220, 230, and 240 may provide a different FaaS environment, thereby allowing for FaaS functions, for example, of different types and formats (e.g., AWS® Lambda, Azure®, and IBM® functions). The communication among the nodes 220 through 240 and the services 210 may be performed over a network, e.g., the internet (not shown).

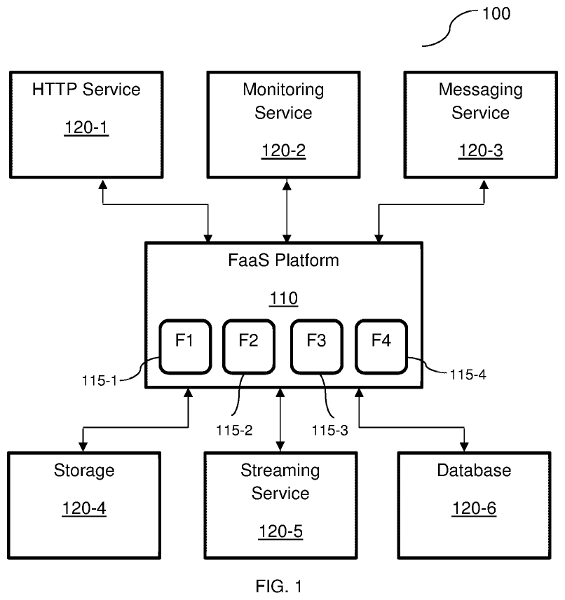

In some implementations, the FaaS platform 200 may allow for seamless migration of functions used by existing customer platforms (e.g., the FaaS platform 110, FIG. 1). The seamless migration may include moving code and configurations to the FaaS platform 200.

FIG. 2B is an example diagram of the FaaS platform 200 utilized to describe a centralized scheduling execution of functions according to an embodiment. As detailed in FIG. 2B, the master node 220 includes a queue 222, a scheduler 224, a load balancer (LB) 227, and an auto-scaler 228. In an example embodiment, a load balancer 227 can be realized as an Internet Protocol Virtual Server (IPVS). The load balancer 227 acts as a load balancer for the pods 231 (in the worker nodes 230) and is configured to allow at most one connection at a time, thereby ensuring that each pod 231 only handles one request at a time. In an embodiment, a pod 231 is available when the number of connections to the pod is zero.

The load balancer 227 is configured to receive requests to run functions by the pods 231 and balance the load among the various pods 231. When such a request is received, the load balancer 227 is first configured to determine if there is an available pod. If so, the request is sent to the available pod at a worker node 230. If no pod is available, the load balancer 227 is configured to send a scan request to the auto-scaler 228. The auto-scaler 228 is further configured to determine the number of pods that would be required to process the function.

The required number of pods is reported to the scheduler 224, which activates one or more pods on the worker node(s) 230. That is, the scheduler 224 is configured to schedule activation of a pod based on demand. An activated pod reports its identifier, IP address, or both, to the load balancer 227. The load balancer 227 registers the activated pod and sends the received request to the newly activated pod.

According to the disclosed embodiments, a proxy 229 is communicatively connected to the load balancer 227 and configured to receive all requests directed to the functions and responses from the functions. The requests can be received from any service 220 and the client 250. In one configuration, the proxy 229 may be configured as a reverse proxy.

According to the disclosed embodiments, the proxy 229 is configured to provide security layers to protect execution of functions in the FaaS platform 200. One security layer, implemented by the proxy 229, is the filtration layer designed to detect attempts to exploit functionality of functions executed in pods 231 through malicious or otherwise illegitimate inputs provided as part of a request to run a function. The filtration layer can also detect functions that already been exploited by filtering malicious or otherwise illegitimate outputs provided as part of the function's response. The security layer is configured to filter inputs and outputs to and from the functions.

According to an embodiment, each serverless function may be configured with a permissive whitelist-based filtration. In another embodiment, heuristic-based filtration is applied when whitelist-based filtration is not possible or not enabled. The input filtration is configured to protect against vulnerabilities such as, but not limited to, cross-site scripting (XSS), local file inclusion (LFI), remote file inclusion (RFI), and the like.

In an embodiment, an output filtration in applied in responses provided by the functions. The output filtration is based on a generalized whitelist searching for specific types of characters in the function's output (response). As an example, the generalized whitelist may filter out: a function returning an integer, a function returning a string, a function returning a string shorter that a predefined number (e.g., 500 characters), and a function returning a string without any HTML tag, and so on. The output filtration is configured to protect against XSS, information disclosure, and data leaks. For example, the output filter of “function returning an integer” may block a function attempting to return an SSN.

The input and output filtration may be defined through a set of filtration rules. Such rules may be defined by a user (e.g., a system administrator). Alternatively, or collectively, filtration rules may be generated by the proxy 229. In this embodiment, functions are learned over time to determine common functions' input and output patterns. The rules are defined to filter out input and/or out that do not comply with the learned patterns. For example, if a function “func1” receives only integer numbers, then a filtration rule for “func1” would require only integer numbers (or filter out any other characters).

In an embodiment, the filtration rules can be realized using regular expressions. A regular expression is a sequence of characters defining a search pattern. Usually such patterns are used by string searching algorithms or input validation.

In an embodiment, to accelerate the execution of a function, a request (including its input) is relayed directly to the load balancer 227 without processing the request in real-time. This may happen when there is a pod 231 ready to run the function. The request including its input is copied and processed by the proxy 229 to perform at least input filtration. If any potential malicious activity is detected by the proxy 229, an event is triggered and sent to the respective pod to halt the execution of the functions. It should be noted that a pod may wait a predefined period before starting the execution of the function to wait for such an event.

In another embodiment, the proxy 229 can be configured to enforce a granular access management on each function. Here an input filtration is applied on a source providing an input to a function. Specifically, metadata associated with source is analyzed before passing the input to the function. The metadata may be analyzed to determine if any attribute (e.g., a source IP address, a username, an agent type, an Operating System type, and the like) comply with a predefined access policy. For example, a policy may define that an input from a source having an IP address X is not allowed.

The access policies may be defined for a specific function, a group of functions, or functions accessed of an application. As such, a group of access policies can be stacked and utilized across the application.

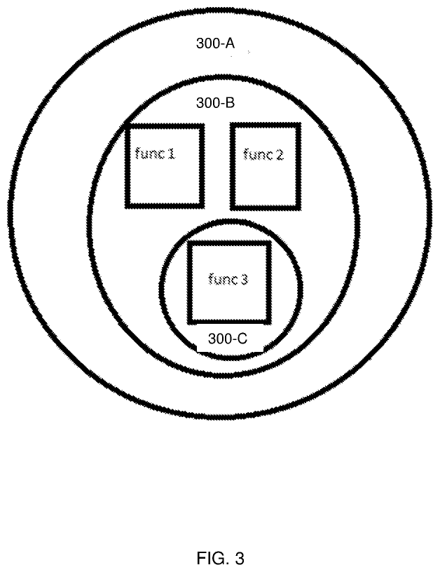

FIG. 3 shows a schematic diagram illustrating the stacking of access polices. In this example, an access policy 300-A does not allow IP address ‘X’, an access policy 300-B does not allow IP address ‘Y’, and an access policy 300-C does allow IP X. In the diagram shown in FIG. 3, the access policy 300-A applies on 3 functions: “func 1”, “func 2”, and “func 3”. The access policy 300-B applies on 2 functions: “func 1” and “func 2”. The policy 300-C applies on a single function: “func 3”.

In order to defend against advanced logical and unknown vulnerabilities, a security layer (“anomaly detection layer”) for detecting such vulnerabilities is provided. In an embodiment, the unknown vulnerabilities are detected using anomaly detection techniques. Specifically, first an exploitation of a vulnerability is detected. Then, any past and future traffic from an attacker is detected and flagged for further analysis. In a further embodiment, a map tracking the attacker activity is generated and reported to a user (e.g., a system administrator).

Referring now to FIG. 2A, the anomaly detection security layer is realized by an anomaly detector 202 and a plurality of agents 201 installed on the platform's nodes, i.e., the master node 220, the worker nodes 230, and the operational node 240. The anomaly detector 202 may be implemented as a pod in the operational node 240. Alternatively, the anomaly detector 202 may be realized as a virtual machine as part of the platform 200.

In an embodiment, each agent 201 is configured to collect, in real-time, data features related to execution of functions in the respective node. The collected data features may include, but is not limited to, a number of invocations from a single source in a time frame, execution flow of a function, and computing resources consumed by a function, and so on. The computing resources consumed by a function may include, for example, a CPU load of a function, a memory usage of a function, a network bandwidth use of a function, an inbound traffic into the function, and so on. Execution flow is the order that the function is called by the application. For example, a “func 1” is first executed and then “func 2” is called.

The agents 201 may also collect security events generated by other security layers implemented in the FaaS platform. Such layers include function execution, network inspection, credentials validation, and filtration. The various layers are configured to generate security events when malicious activity is detected. For example, the function execution layer may generate a security event when illegal execution flow of a function is detected. As another example, the network inspection layer may trigger a security event when malicious traffic is generated by a function (e.g., accessing a control and command server). As yet another example, the credentials validation layer may issue a security event when function's credentials are compromised.

The data collected by the agents 201 are sent to the anomaly detector 202 which is configured to aggregate the data per function or a group of functions. In an embodiment, a baseline may be determined for each function during a predefined learning period. The baseline may determine a normal behavior for the function based on the one or more of the collected data features. A baseline may be determined also for a group of functions, for example, executed parts of the function.

As an example, a baseline may model the normal execution flow of a function. As another example, a baseline may model normal input patterns received by a function (e.g., only integers). As yet another example, the baseline may model average consumption of computing resources by the function (e.g., using 512 MB of memory when running a function). A baseline determined for a function may include any combination of the above examples.

An anomaly is detected based on a deviation for a learned normal execution, i.e., the determined baseline. In an embodiment, the anomaly is detected by constantly collecting the data features as provided by the agents 201, aggregating the data for each feature and per each function, and comparing the aggreged data to the determined respective baseline. For example, an execution flow of a function may be determined by collecting calls for invoking functions. The execution flow as determined by the collected data is compared to a normal execution flow baseline of the respective function.

In an embodiment, a score is computed for each determined deviation and an alert is reported based on the computed score (e.g., when the score is determined over a predefined threshold). To compute the score, the security events generated by the other layers are factored. For example, a security event provided by the filtration layer together with a deviation from a normal input patterns baseline may increase the value of a computed score. Factoring security events increases the confidence that an attack is being performed and reduces the number of false positive alerts.

In an embodiment, an attack map is generated based the generated alerts. The map may indicate functions that have been exploited, an application or applications executing such functions, resources accessed by such functions, and so on. The map allows an administrator to track the attacker activity throughout the FaaS platform.

It should be further noted each of the nodes (shown in FIGS. 2A, 2B) requires an underlying hardware layer (not shown in FIGS. 2A, 2B) to execute the operating system, the pods, load balancers, and other functions of the master node.

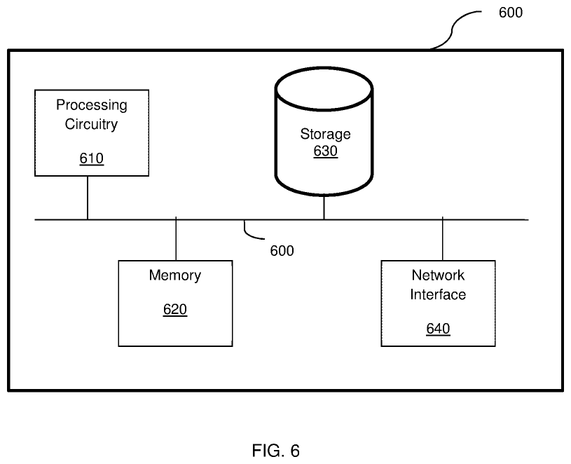

An example block diagram of a hardware layer is provided in FIG. 6. Furthermore, the various elements of the nodes 220 and 240 (e.g., the scheduler, autoscaler, pollers, event bus, log aggregator, etc.), the agents 201 and anomaly detector 202 can be realized as pods. As noted above, a pod is a software container. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). Such Instructions are executed by the hardware layer.

It should be understood that the embodiments described herein are not limited to the specific architecture illustrated in FIGS. 1, 2A and 2B, and that other architectures may be equally used without departing from the scope of the disclosed embodiments. Specifically, the services 220 are merely examples, and that more, fewer, or other services may be provided functions by the FaaS platform 200 according to the disclosed embodiments. The services 220 may be hosted in an external platform (e.g., a platform of a cloud service provider utilizing the provided functions in its services). Requests from the services 220 may be delivered via one or more networks (not shown). It should also be noted that the numbers and arrangements of the nodes and the pods 231 are merely illustrative, and that other numbers and arrangements may be equally utilized. In particular, the number of pods 231 may be dynamically changed as discussed herein to allow for scalable provisions of functions.

It should also be noted that the flows of requests shown in FIGS. 2A and 2B (as indicated by dashed lines with arrows in FIGS. 2A and 2B) are merely examples used to demonstrate various disclosed embodiments and that such flows do not limit the disclosed embodiments.

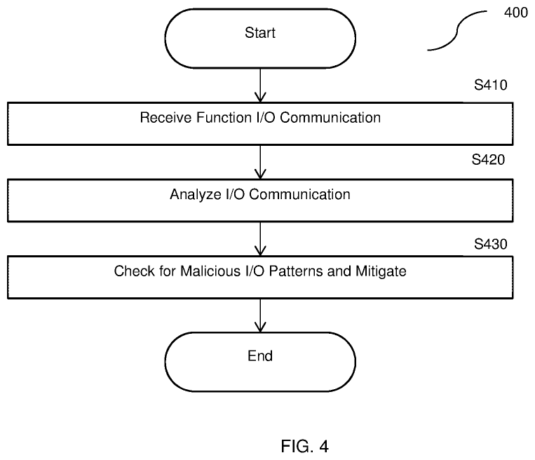

FIG. 4 is an example flowchart 400 illustrating a process performed by the filtration security layer according to an embodiment.

Prior to the execution of the process a set of filtration rules are determined or otherwise defined by the user. A filtration rule is defined based on common and legitimate inputs and outputs of the function. In an embodiment, a filtration rule is realized using a regular expression.

At S410, an input/output communication of function is received. The input communication includes inputs that are part of a request to run a function. The output communication includes outputs that are part of the function's response. In an embodiment, the input/output communication is received in real-time (e.g., when a client send a request to run a function). In another embodiment, the input/output communication is a copy of the request's inputs' or response's outputs.

At S420 input/output communication is analyzed to detect malicious patterns in either the inputs or outputs. The malicious patterns may include uncommon, illegitimate, or irregular patterns. Specifically, S420 includes applying the predefined set of filtration rules on the inputs and/or outputs included in the input/output communication. When implementing the filtration rules using the regular expressions, each regular expression is configured to search for patterns defined with the respective rule. Some examples of applying the filtration rules are discussed above.

At S430, it is checked if a malicious pattern is detected in either the analyzed inputs or outputs. If so, an action is performed to mitigate potential harm that may be caused by the such malicious pattern. For example, an action may include halting a pod from running a function, not scheduling a function for execution, blocking function's response from reaching the client, and so on. In an embodiment, an alert reporting any detected malicious pattern, the related function, and the source generating the malicious may be reported as well.

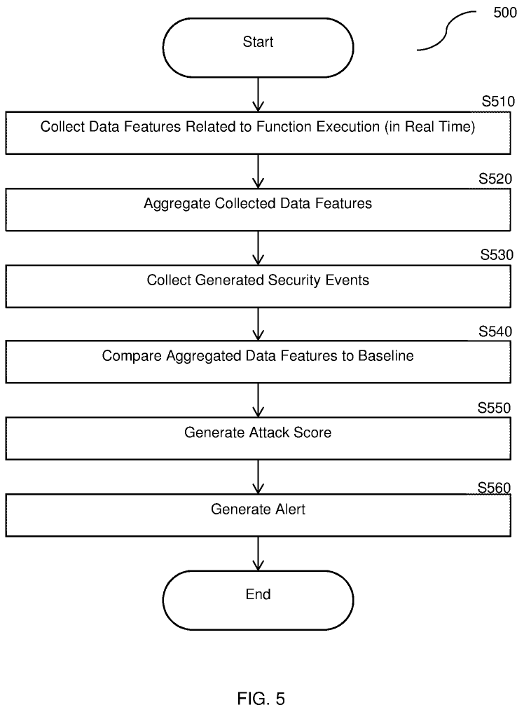

FIG. 5 is an example flowchart 500 illustrating a process performed by the anomaly detection security layer according to an embodiment. The anomaly detection security layer, when processed, can be utilized to detect unknown vulnerabilities.

At S510, data features related to the execution of each function are collected in real time. The data features include, for example, a number of invocations from a single source in a time frame, execution flow of a function, computing resources consumed by a function, and so on.

At S520, the collected data features are aggregated. The aggregation may be over a predefined period or a predefined number of iterations that the function has been executed. Information collected can be aggregated per data feature and per function or a group of functions. Some examples are provided above.

At S530, security events generated by other security layers operable in the FaaS platform are collected. Examples for security layers include function execution, network inspection, credentials validation, and filtration. In an embodiment, security events from external systems (e.g., SIEM systems) and/or the underlined cloud infrastructure may be collected. Such events may be indicative on malicious activity.

At S540, the aggregated data features of each function or a group of functions are compared to a baseline utilized to model a normal behavior function. Examples for baselines that may be utilized to monitor the behavior of functions are provided above.

At S550, an attack score is generated based on the comparison and the collected security events. In an example embodiment, the value of the attack score is higher when a deviation from the baseline is detected and security events are received.

At S560, based on the valued of the attack score, an alert indicating a potential malicious activity is generated. In an embodiment, when the attack score is above a predefined threshold, an alert is generated.

FIG. 6 is an example block diagram of a hardware layer 600 included in each node according to an embodiment. That is, each of the master node, operational node, and worker node is independently executed over a hardware layer, such as the layer shown in FIG. 6. In an embodiment, the reverse proxy may be realized or executed over the hardware layer 600.

The master node 211-1 includes a processing circuitry 610 coupled to a memory 620, a storage 630, and a network interface 640. In another embodiment, the components of the master node 211-1 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 620 may be volatile (e.g., RAM, etc.), non-volatile (e.g., ROM, flash memory, etc.), or a combination thereof. In one configuration, computer readable instructions to implement one or more embodiments disclosed herein may be stored in the storage 630.

In another embodiment, the memory 620 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, configure the processing circuitry 610 to perform the various processes described herein.

The storage 630 may be magnetic storage, optical storage, and the like, and may be realized, for example, as flash memory or other memory technology, CD-ROM, Digital Versatile Disks (DVDs), or any other medium which can be used to store the desired information.

The network interface 640 allows the master node 211-1 to communicate over one or more networks, for example, to receive requests for functions from user devices (not shown) for distribution to software containers (e.g., the pods 216, FIG. 2).

It should be understood that the embodiments described herein are not limited to the specific architecture illustrated in FIG. 6, and other architectures may be equally used without departing from the scope of the disclosed embodiments. [0093]The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for protecting a serverless Function as a Service (FaaS) platform from vulnerabilities, comprising:
receiving input and output (I/O) communication directed to a serverless function executed over the FaaS platform;
analyzing the received I/O communication by applying a predefined set of filtration rules, wherein the predefined set of filtration rules input filtration rules and output filtration rules are independently applied on the received I/O communication;
detecting, based on the predefined set of filtration rules analysis, at least one malicious I/O pattern; and
alerting on a detection of vulnerability when deterring the at least one malicious I/O pattern.

2. The method of claim 1, further comprising:
causing execution of a mitigation action when detecting a vulnerability.

3. The method of claim 1, wherein the input communication includes requests to execute the serverless function.

4. The method of claim 1, wherein the output communication includes responses provided by the serverless function.

5. The method of claim 1, wherein the input filtration is configured to filter known vulnerabilities.

6. The method of claim 1, wherein analyzing I/O communication further comprises:
applying regular expressions, wherein each of the regular expressions is configured to search for patterns defined with the respect to the rule.

7. The method of claim 1, wherein the output filtration rules are permissive whitelist-based.

8. The method of claim 1, wherein the output filtration rules are heuristic-based filtration.

9. The method of claim 1, wherein the received I/O communication is a copy of the actual communication.

10. The method of claim 1, further comprising:
receiving the I/O communication by a reverse proxy, wherein the reverse proxy is deployed between a client device and the FaaS platform.

11. A non-transitory computer readable medium having stored thereon instructions for causing a processing circuitry to execute a process for protecting a serverless Function as a Service (FaaS) platform from vulnerabilities, comprising:
receiving input and output (I/O) communication directed to a serverless function executed over the FaaS platform;
analyzing the received I/O communication by applying a predefined set of filtration rules, wherein the predefined set of filtration rules input filtration rules and output filtration rules being independently applied on the received I/O communication;
detecting based on the predefined set of filtration rules analysis, at least one malicious I/O pattern; and
alerting on a detection of vulnerability when deterring the at least one malicious I/O pattern.

12. A reverse proxy for protecting a serverless Function as a Service (FaaS) platform from vulnerabilities, comprising:
a processing circuitry; and
a memory, the memory containing instructions that, when executed by the processing circuitry, configure the reverse proxy to:
receive input and output (I/O) communication directed to a serverless function executed over the FaaS platform;
analyze the received I/O communication by applying a predefined set of filtration rules, wherein the predefined set of filtration rules input filtration rules and output filtration rules being independently applied on the received I/O communication;
detect based on the predefined set of filtration rules analysis, at least one malicious I/O pattern; and
alert on a detection of vulnerability when deterring the at least one malicious I/O pattern.

13. The reverse proxy of claim 12, wherein the reverse proxy is further configured to:
cause execution of a mitigation action when detecting the detection of vulnerability.

14. The reverse proxy of claim 12, wherein the input communication includes requests to execute the serverless function.

15. The reverse proxy of claim 12, wherein the output communication includes responses provided by the serverless function.

16. The reverse proxy of claim 12, wherein the input filtration is configured to filter known vulnerabilities.

17. The reverse proxy of claim 12, wherein the reverse proxy is further configured to:
apply regular expressions, wherein each of the regular expressions is configured to search for patterns defined with the respect to the rule.

18. The reverse proxy of claim 12, wherein the output filtration rules are permissive whitelist-based.

19. The reverse proxy of claim 12, wherein the output filtration rules are heuristic-based filtration.

20. The reverse proxy of claim 12, wherein the received I/O communication is a copy of the actual communication.

21. The reverse proxy of claim 12, wherein the reverse proxy is further configured to:
receive the I/O communication by a reverse proxy, wherein the reverse proxy is deployed between a client device and the FaaS platform.
